(19) United States
(12) Patent Application Publication
(10) Pub. No.: US 2016/0118037 A1
(43) Pub. Date: Apr. 28, 2016

(54) APPARATUS FOR OUTPUTTING PROTECTING SOUND IN QUIETING VEHICLE

(71) Applicant: Hyundai Motor Company, Seoul (KR)

(72) Inventors: Tae Kun Yun, Anyang (KR); Dong Chul Park, Anyang (KR); Do Young Park, Seoul (KR)

(21) Appl. No.: 14/619,761

(22) Filed: Feb. 11, 2015

(30) Foreign Application Priority Data
Oct. 28, 2014 (KR) 10-2014-0147693

(51) Int. Cl. G10K 11/178

(52) U.S. Cl. CPC G10K 11/178

(57) ABSTRACT

An apparatus and method for outputting a protecting sound in a quieting vehicle is provided. The apparatus includes a storage unit that is configured to store a mapping table in which protecting sounds having frequency bands that are exponentially increased for each vehicle speed are mapped. In addition, a controller is configured to output the protecting sound of the frequency band that corresponds to the current vehicle speed using the mapping table when the vehicle is being driven by an electric motor.

### CROSS-REFERENCE TO RELATED APPLICATION

This application is based on and claims the benefit of priority to Korean Patent Application No. 10-2014-0147693, filed on Oct. 28, 2014 in the Korean Intellectual Property Office, the disclosure of which is incorporated herein in its entirety by reference.

### TECHNICAL FIELD

The present disclosure relates to an apparatus and method for outputting a protecting sound in a quieting vehicle and more particularly, to a technology of exponentially increasing and outputting a protecting sound in response to a vehicle speed in a quieting vehicle.

### BACKGROUND

Today, as environmental pollution increasingly becomes an issue, each technical field and industries are competing to develop environmentally-friendly energy. In addition, due to the depletion of petroleum, natural resources, and the like, a competition for developing alternative energy sources is increasing. Accordingly, automobile manufacturers are competing to develop a next-generation vehicle. A hybrid vehicle and an electric vehicle using a battery as an energy source have been developed.

In particular, a hybrid vehicle is driven by an electric motor when being driven at a substantially low speed of about 0 to 20 km/h and is driven by an engine when being driven at a substantially high speed (e.g., greater than about 20 km/h) and the electric vehicle is driven by the electric motor. When a quieting vehicle (e.g., a vehicle which emits minimal noise while being driven) is driving at a low speed, pedestrians and other objects may have difficulty to recognize a motion of a vehicle since the quieting vehicle emits minimal noise, such that persons with difficulty in either seeing or hearing may have an increased risk of a traffic accident. Therefore, a need exists for an apparatus for safely protecting pedestrians when a quieting vehicle is driving at a substantially low speed.

### SUMMARY

The present disclosure provides an apparatus and method for outputting a protecting sound in a quieting vehicle capable of exponentially increasing and outputting a protecting sound in response to a vehicle speed in a quieting vehicle.

According to an exemplary embodiment of the present disclosure, an apparatus for outputting a protecting sound in a quieting vehicle may include a storage unit configured to store a mapping table in which protecting sounds having frequency bands that are exponentially increased for each vehicle speed are mapped; and a controller configured to output the protecting sound of the frequency band that corresponds to the current vehicle speed using the mapping table when the vehicle is driven by an electric motor.

The apparatus may further include: a protecting sound output unit configured to be operated by the controller to output the protecting sound. In the protecting sound output unit, an audio gain may be operated by the controller to match the frequency band of the protecting sound. Further, the apparatus may further include: a communication interface configured to receive vehicle speed information and engine revolutions per minute (RPM) information and transmit the received vehicle speed information and engine RPM information to the controller. The controller may be configured to use the engine RPM information to determine whether the vehicle uses the electric motor.

According to another exemplary embodiment of the present disclosure, a method for outputting a protecting sound in a quieting vehicle may include receiving vehicle information; and exponentially adjusting and outputting the protecting sound in response to a change in a vehicle speed of the vehicle, based on vehicle speed information among the vehicle information when the vehicle is being driven by an electric motor.

The method may further include: prior to the exponentially adjusting and outputting of the protecting sound, determining whether the vehicle is being driven by the electric motor based on engine RPM information among the vehicle information. The method may further include: prior to the receiving of the vehicle information, previously storing a mapping table in which frequency band information due to an exponential increase in the protecting sounds for each vehicle speed is mapped.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary configuration diagram of an apparatus for outputting a protecting sound in a quieting vehicle according to an exemplary embodiment of the present disclosure;

FIG. 2 is an exemplary table showing exponentially increasing protecting sounds in the quieting vehicle according to the exemplary embodiment of the present disclosure;

FIG. 3 is an exemplary graph illustrating that the protecting sound in the quieting vehicle according to the exemplary embodiment of the present disclosure is exponentially increased;

FIG. 4 is an exemplary diagram for describing a merit of the exponential increase in the protecting sound in the quieting vehicle according to the exemplary embodiment of the present disclosure; and

FIG. 5 is an exemplary flow chart illustrating a method for outputting a protecting sound in a quieting vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Although exemplary embodiments are described as using a plurality of units to perform the exemplary process, it is understood that the exemplary process may also be performed by one or a plurality of modules. Additionally, it is understood that the term controller/control unit refers to a hardware device that includes a memory and a process. The memory is configured to store the modules and the process is specifically configured to execute said modules to perform one or more processes which are described further below.

Furthermore, control logic of the present invention may be embodied as non-transitory computer readable media on a computer readable medium containing executable program instructions executed by a process, controller or the like. Examples of the computer readable mediums includes, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distribute fashion, e.g., by a telematics server of a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings so that those skilled in the art may easily implement the spirit of the present disclosure.

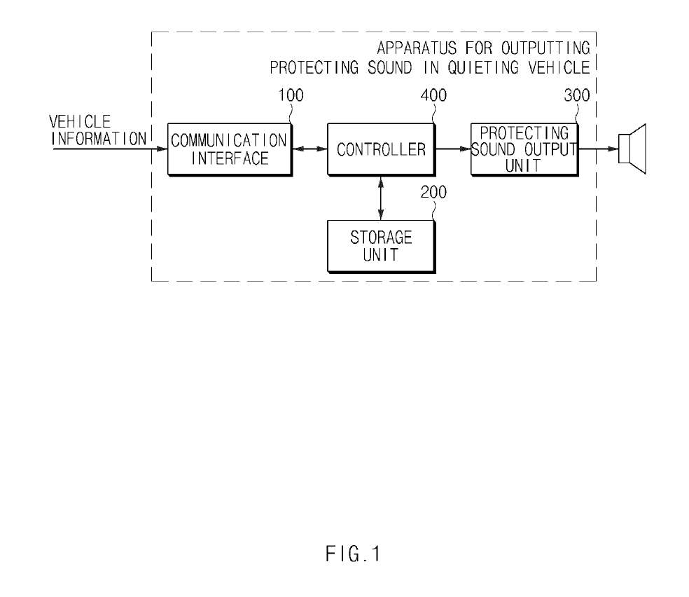

The present disclosure may allow pedestrians or other surrounding objects to recognize a quieting vehicle by exponentially increasing and outputting a protecting sound in response to a vehicle speed when the quieting vehicle such as a hybrid vehicle and an electric vehicle is being driven. Hereinafter, exemplary embodiments of the present disclosure will be described in detail with reference to FIGS. 1 to 5.

FIG. 1 is an exemplary configuration diagram of an apparatus for outputting a protecting sound in a quieting vehicle according to an exemplary embodiment of the present disclosure. Referring to FIG. 1, the apparatus for outputting a protecting sound in a quieting vehicle according to the exemplary embodiment of the present disclosure may include a communication interface 100, a storage unit 200, a protecting sound output unit 300, and a controller 400. The controller 400 may be configured to operate the communication interface 100, the storage unit 200, and the protecting sound output unit 300.

The communication interface 100 is an interface within a vehicle network In this configuration, the vehicle network may be a controller area network (CAN) and may be configured to receive vehicle information such as vehicle speed information and RPM information from a module (e.g., various sensors) mounted within a vehicle connected to the vehicle network The storage unit 200 is a memory which may be configured to store a mapping table that shows protecting sounds whose frequency bands are exponentially increased in response to a change in a vehicle speed and the protecting sound.

The protecting sound output unit 300 may include an amplifier configured to amplify the protecting sound and output the amplified protecting sound via a speaker and may have a gain control function to adjust a protecting sound gain. The controller 400 may be a Micom configured to operate the apparatus for outputting a protecting sound in a quieting vehicle. The controller 400 may be configured to receive a CAN message via the communication interface 100 and analyze the received CAN message to confirm the vehicle information such as vehicle speed information and engine RPM information included in the CAN message.

The controller 400 may further be configured to determine whether an electric motor is operating based on the engine RPM information. The engine RPM may be about 500 RPM or less when the electric motor is operated at a substantially low speed of about 20 km/h or less. Therefore, the controller 400 may be configured to determine whether the electric motor is operating based on the engine RPM information. In response to determining that the electric motor is operating, the controller 400 may be configured to access (e.g., use) the mapping table stored in the storage unit 200 to output the protecting sound of the frequency band that corresponds to the current vehicle speed information to the protecting sound output unit 300. In particular, exponential increase logic of the protecting sound in response to a vehicle speed is represented by the following Equation 1.

Protecting sound (%)=(100+α%)^{V} Equation 1

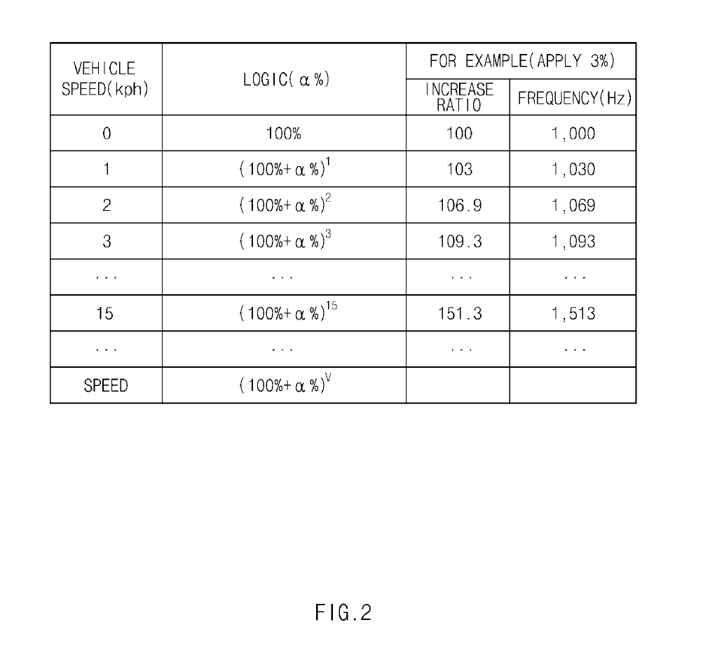

In the above Equation 1, v represents the vehicle speed information and a represents an increase amount. Assuming that α is about 3%, the mapping table for the exponentially increasing protecting sounds in response to the vehicle speed is as the following FIG. 2.

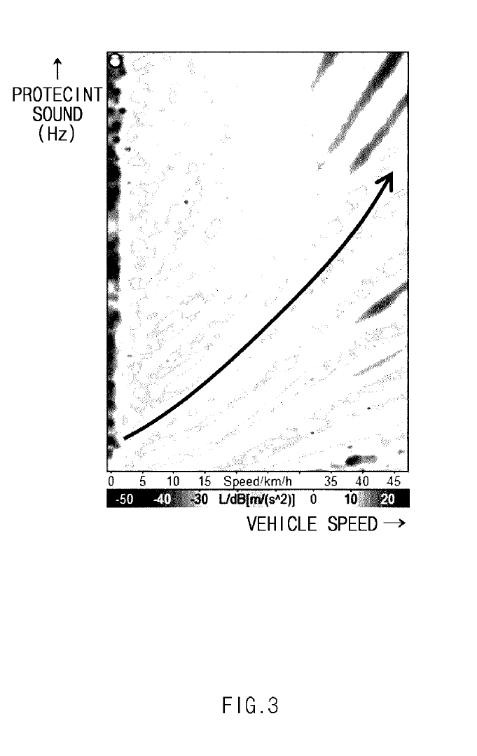

Referring to FIG. 2, when the vehicle speed is sequentially increased to about 0, 1, 2, and 3, the frequency band of the protecting sound may increase exponentially to about 1000 Hz, 1030 Hz, 1069 Hz, 1093 Hz and the same, which are illustrated in a graph of FIG. 3.

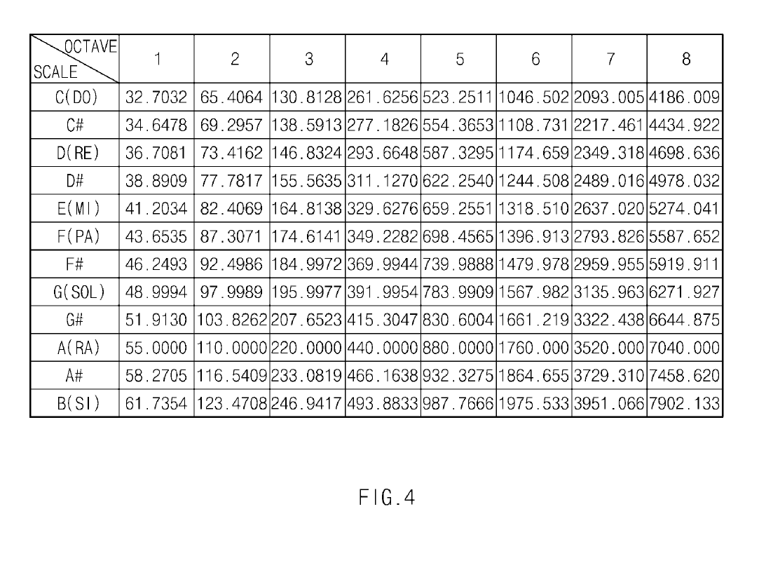

The exponential increase of the protecting sound may be well recognized by pedestrians. FIG. 4 illustrates a standard frequency in which octave steps for each scale are 1 to 8. In the octave step of scale A (RA) 500, it may be appreciated that a note above 1 octave may be increased to two times, a note above 2 octave may be increased to four times, and a note above 3 octave may be increased to eight times. The above described relations represent a human body that experiences a relative pitch for a substantial period of time to recognize a note above 1 octave as two times, a note above 2 octave as four times, and a note above 3 octave as eight times. In other words, it may be appreciated that the human body may recognize a note as an exponential change. Therefore, for the exponentially increasing and outputting of the protecting sound, pedestrians may more clearly recognize the change in speed of the corresponding vehicle.

The controller 400 may be configured to adjust a protecting sound gain of the protecting sound output unit 300 to output the protecting sound of the frequency band that corresponds to the vehicle speed information. The protecting sound output unit 300 may be configured to amplify a virtual engine sound and output the amplified virtual engine sound through the speaker. As described above, the present disclosure may be configured to determine whether the protecting sound is output based on the engine RPM and exponentially increase and output the frequency band of the protecting sound in response to the vehicle speed to enable pedestrians to more clearly recognize the vehicle.

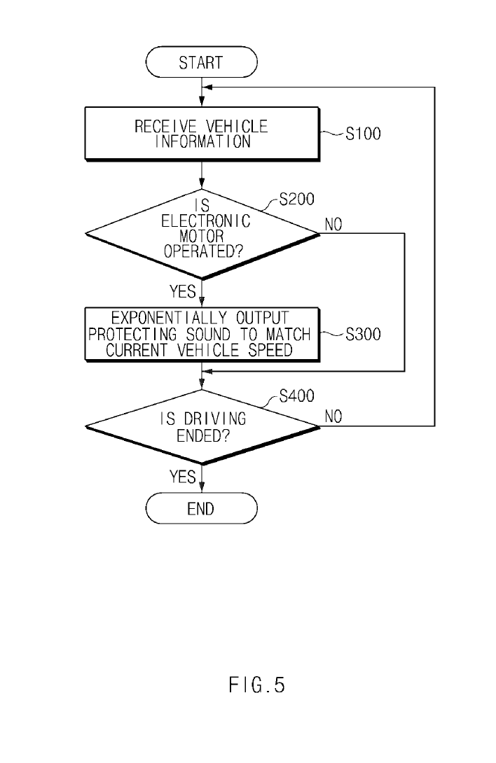

Hereinafter, a method for exponentially outputting a protecting sound in a quieting vehicle according to an exemplary embodiment of the present disclosure will be described in detail with reference to FIG. 5. First, the controller 400 may be configured to receive the CAN message including the vehicle speed information and the engine RPM information via the communication interface 100 (S100).

The controller 400 may be configured to determine whether the electric motor is operating based on the received engine RPM information (S200). In particular, when the engine RPM is equal to or less than a predetermined engine RPM, the controller 400 may be configured to use the electric motor as a power source to determine whether the vehicle is driving. Therefore, in response to determining that the current vehicle is driving by the electric motor, the controller 400 may be configured to access the mapping table stored in the storage unit 200 to output the protecting sound that corresponds to the current vehicle speed information to the protecting sound output unit 300 (S300).

Furthermore, the controller 400 may be configured to determine whether the driving of the vehicle ends (e.g., whether the vehicle is no long being driven, the vehicle driving is terminated, etc.) based on a start-up state, and the like and in response to determining that the driving of the vehicle ends, terminate the foregoing process (S400). In particular, the controller 400 may be configured to continuously detect the vehicle speed information in real time when the vehicle is being driven by the electric motor to output the protecting sound exponentially adjusting in response to the vehicle speed in real time.

As described above, the present disclosure may be configured to exponentially increase and output the protecting sound in the quieting vehicle in response to the vehicle speed to enable pedestrians to more easily detect the vehicle speed based on the protecting sound.

As described above, according to the exemplary embodiments of the present disclosure, it may be possible to prevent safety accidents by outputting the protecting sound when the quieting vehicle is being driven at a substantially low speed to enable pedestrians to recognize the driving of the quieting vehicle. Further, according to the exemplary embodiments of the present disclosure, it may be possible to enable pedestrians to more easily recognize the vehicle speeds for each frequency band of the protecting sound by exponentially increasing the protecting sound to increase the efficiency of allowing pedestrians recognize the driving of the quieting vehicle.

The exemplary embodiments of the present disclosure described above have been provided for illustrative purposes. Therefore, those skilled in the art will appreciate that various modifications, alterations, substitutions, and additions are possible without departing from the scope and spirit of the present disclosure as disclosed in the accompanying claims and such modifications, alterations, substitutions, and additions fall within the scope of the present disclosure.

What is claimed is:

1. An apparatus for outputting a protecting sound in a quieting vehicle, comprising:
a storage unit configured to store a mapping table in which protecting sounds having frequency bands which are exponentially increased for each vehicle speed are mapped; and
a controller configured to output the protecting sound of the frequency band that corresponds to the current vehicle speed using the mapping table when the vehicle is being driven by an electric motor.

2. The apparatus according to claim 1, further comprising:
a protecting sound output unit operated by the controller to output the protecting sound.

3. The apparatus according to claim 2, wherein the protecting sound output unit is configured to adjust an audio gain to match the frequency band of the protecting sound.

4. The apparatus according to claim 1, further comprising:
a communication interface configured to receive vehicle speed information and engine revolutions per minute (RPM) information and transmit the received vehicle speed information and engine RPM information to the controller.

5. The apparatus according to claim 4, wherein the controller is configured to access the engine RPM information to determine whether the vehicle uses the electric motor.

6. A method for outputting a protecting sound in a quieting vehicle, comprising:
receiving, by a controller, vehicle information; and
exponentially adjusting and outputting, by the controller, the protecting sound in response to a change in a vehicle speed of the vehicle, based on vehicle speed information among the vehicle information when the vehicle is being driven by an electric motor.

7. The method according to claim 6, further comprising:
prior to the exponentially adjusting and outputting of the protecting sound, determining, by the controller, whether the vehicle is being driven by the electric motor based on engine revolutions per minute (RPM) information among the vehicle information.

8. The method according to claim 6, further comprising:
prior to the receiving of the vehicle information, previously storing, by the controller, a mapping table in which frequency band information due to an exponential increase in the protecting sounds for each vehicle speed is mapped.

9. A non-transitory computer readable medium containing program instructions executed by a processor or controller, the computer readable medium comprising:
program instructions that receive vehicle information; and
program instructions that exponentially adjust and output the protecting sound in response to a change in a vehicle speed of the vehicle, based on vehicle speed information among the vehicle information when the vehicle is being driven by an electric motor.

10. The non-transitory computer readable medium of claim 9, further comprising:
program instructions that determine whether the vehicle is being driven by the electric motor based on engine revolutions per minute (RPM) information among the vehicle information, prior to the exponentially adjusting and outputting of the protecting sound.

11. The non-transitory computer readable medium of claim 9, further comprising:
program instructions that previously store a mapping table in which frequency band information due to an exponential increase in the protecting sounds for each vehicle speed is mapped, prior to the receiving of the vehicle information.
